(19) United States
(12) Patent Application Publication
(10) Pub. No.: US 2026/0169482 A1
(43) Pub. Date: Jun. 18, 2026

(54) UNMANNED VEHICLE BACKING CONTROL METHOD, UNMANNED VEHICLE, AND COMPUTER-READABLE STORAGE MEDIUM

(71) Applicant: UBTECH ROBOTICS CORP LTD, Shenzhen (CN)

(72) Inventors: XIN FU, Shenzhen (CN); Jinbing Xiong, Shenzhen (CN)

(21) Appl. No.: 19/419,204

(22) Filed: Dec. 15, 2025

(30) Foreign Application Priority Data
Dec. 17, 2024 (CN) 202411872960.7

(51) Int. Cl. G05D 1/43; G05D 1/646

(52) U.S. Cl. CPC G05D 1/43; G05D 1/646

(57) ABSTRACT

An unmanned vehicle backing control method, an unmanned vehicle, and a computer-readable storage medium. The method includes: obtaining a target position by determining a position on an extension line of a target line segment in response to detecting that the unmanned vehicle deviates from a target trajectory during backing and an extension direction of the extension line of the target line segment is from a front axle center to a rear axle center of the unmanned vehicle; obtaining a lateral deviation by determining a distance between the target position and the target trajectory; and determining a steering angle of the unmanned vehicle based on the lateral deviation, and performing a backing control on the unmanned vehicle based on the steering angle. In this manner, the accuracy of the backing control of the unmanned vehicle can be improved.

### CROSS REFERENCE TO RELATED APPLICATIONS

The present disclosure claims priority to Chinese Patent Application No. 202411872960.7, filed Dec. 17, 2024, which is hereby incorporated by reference herein as if set forth in its entirety.

### TECHNICAL FIELD

The present disclosure relates to unmanned vehicle control technology, and particularly to an unmanned vehicle backing control method, an unmanned vehicle, and a computer-readable storage medium.

### BACKGROUND

With the development of science and technology, there emerges self-driving vehicles that are also called as unmanned vehicles.

Before driving an unmanned vehicle, it usually set a target trajectory (or referred to as a reference path or a planned path) for the unmanned vehicle. However, during driving the unmanned vehicle, its actual trajectory could deviate from the target trajectory. In this case, a steering angle of the unmanned vehicle needs to be adjusted to reduce the deviation of the actual trajectory of the unmanned vehicle with respect to the target trajectory. For example, during backing, it may obtain a lateral deviation by calculating a horizontal distance between an actual position of the unmanned vehicle and the target trajectory, then determine the steering angle of the unmanned vehicle based on the lateral deviation, and finally adjust the actual trajectory of the unmanned vehicle according to the steering angle.

In the existing unmanned vehicle backing control methods, the center of ta front axle of the unmanned vehicle or that of a rear axle of the unmanned vehicle may be used to calculate the lateral deviation of the unmanned vehicle. However, no matter which method is used to calculate the lateral deviation, whenever the steering angle of the unmanned vehicle is calculated based on the lateral deviation to use the steering angle to adjust the driving trajectory of the unmanned vehicle, low accuracy will be caused.

### BRIEF DESCRIPTION OF DRAWINGS

In order to explain the technical schemes in the embodiments of the present disclosure more clearly, the drawings needed to be used in the descriptions of the embodiments or the prior art will be briefly introduced below.

FIG. 1 is a schematic diagram of the relationship between an unmanned vehicle and a target trajectory during backing according to an embodiment of the present disclosure.

FIG. 2 is a flow chart of an unmanned vehicle backing control method according to an embodiment of the present disclosure.

FIG. 3 is a schematic diagram of a lateral deviation according to an embodiment of the present disclosure.

FIG. 4 is a schematic diagram of a target position determined according to a wheelbase and a rear axle center according to an embodiment of the present disclosure.

FIG. 5 is a schematic diagram of determining a target position according to a reference position according to an embodiment of the present disclosure.

FIG. 6 is a schematic diagram of the structure of an unmanned vehicle backing control apparatus according to an embodiment of the present disclosure.

FIG. 7 is a schematic diagram of the structure of a control device according to an embodiment of the present disclosure.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

It is to be understood that, when used in the description and the appended claims of the present disclosure, the terms “including” and “comprising” indicate the described features, integers, steps, operations, elements and/or components, but do not preclude the presence or addition of one or a plurality of other features, integers, steps, operations, elements, components and/or combinations thereof.

It is also to be understood that the term “and/or” used in the description and the appended claims of the present disclosure refers to any combination of one or more of the associated listed items and all possible combinations, and includes such combinations.

References such as “one embodiment” and “some embodiments” in the specification of the present disclosure mean that the particular features, structures or characteristics described in combination with the embodiment(s) are included in one or more embodiments of the present disclosure. Therefore, the sentences “in one embodiment”, “in some embodiments”, “in other embodiments”, “in other embodiments” and the like in different places of this specification are not necessarily all refer to the same embodiment, but mean “one or more but not all embodiments” unless specifically emphasized otherwise.

During controlling an unmanned vehicle, if an actual trajectory (i.e., the actual trajectory of movement) of the unmanned vehicle is detected to have a deviation with respect to a target trajectory, the actual trajectory of the unmanned vehicle may be adjusted by backing and dynamically adjusting a steering angle to reduce the deviation between the actual trajectory and the target trajectory.

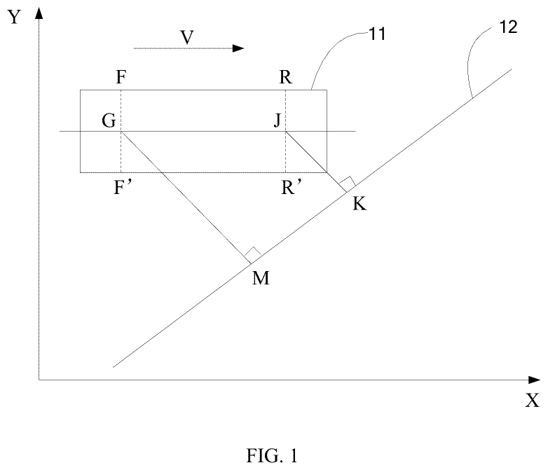

FIG. 1 is a schematic diagram of the relationship between an unmanned vehicle and a target trajectory during backing according to an embodiment of the present disclosure. As shown in FIG. 1, the direction of the front of the unmanned vehicle 11 is the direction which \vec{JG} is pointing, FF′ is a front axle of the unmanned vehicle 11, G is the center of FF′, RR′ is a rear axle of the unmanned vehicle 11, and J is the center of RR′. It can be seen from FIG. 1 that there is a deviation between the current position of the unmanned vehicle 11 and the target trajectory 12. In this case, the unmanned vehicle 11 will back (i.e., reverse) in the direction pointed by “V”. During backing, the steering angle of the unmanned vehicle 11 is adjusted to reduce the deviation between the actual trajectory of the unmanned vehicle 11 and the target trajectory 12.

Before adjusting the steering angle, it may first determine the lateral deviation between the unmanned vehicle 11 and the target trajectory 12, and then determine the steering angle to be adjusted based on the lateral deviation.

In forward driving scenarios, a front axle center (i.e., the center of the front axle) may be used as a vehicle reference point to calculate the lateral deviation (i.e., line segment GM in FIG. 1) between the unmanned vehicle and the target trajectory by, for example, using the Stanley algorithm to calculate the steering angle based on the lateral deviation. In practical applications, the steering angle calculated using this method will have smaller control deviations and higher robustness. However, in backward driving scenarios, if it still uses the front axle center as the vehicle reference point, unstable control will be caused due to kinematic differences. Therefore, for backward driving scenarios, in the original paper of Stanley and other related papers, calculating the lateral deviation (e.g., line segment JK in FIG. 1) using the rear axle center as the vehicle reference point is proposed. When line segment JK is used as the lateral deviation to calculate the steering angle, the control performance can be improved to a certain extent, while the overall robustness is still poor and the control performance is sensitive to control parameters (e.g., the steering angle).

In this embodiment, in order to improve the robustness of path following of the unmanned vehicle in backward driving scenarios by adjusting the steering angle, an unmanned vehicle backing control method is provided.

In the unmanned vehicle backing control method, it determines a position on the extension line from the front axle center of the unmanned vehicle to the rear axle center, and determines the lateral deviation based on the position and the rear axle center. In this foregoing manner, since the determined position is equivalent to the lateral deviation determined based on the forward direction of the unmanned vehicle when the unmanned vehicle drives forward, the accuracy of the determined lateral deviation is improved to improve the accuracy of the subsequent control of the unmanned vehicle.

In this embodiment, the unmanned vehicle backing control method will be described below with reference to the drawings.

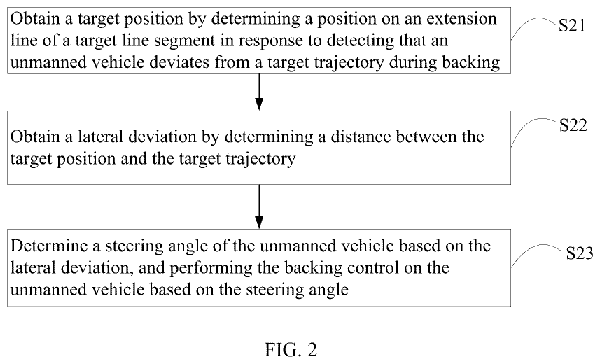

FIG. 2 is a flow chart of an unmanned vehicle backing control method according to an embodiment of the present disclosure. In this embodiment, the unmanned vehicle backing control method may be applied to (a processor of) an unmanned vehicle such as a self-driving automobile. The method may be applied to a controller of the unmanned vehicle. As shown in FIG. 2, the unmanned vehicle backing control method may include the following steps.

S21: obtaining a target position by determining a position on an extension line of a target line segment in response to detecting that the unmanned vehicle deviates from a target trajectory during backing, where the target line segment is a line segment corresponding to a distance between a front axle center and a rear axle center of the unmanned vehicle, and an extension direction of the extension line of the target line segment is from the front axle center to the rear axle center.

In which, the target trajectory is a trajectory for a task of the unmanned vehicle that is set in advance before the unmanned vehicle executing the task, which usually includes position information, and may further include control quantity information such as speed and acceleration.

In some embodiments, during driving the unmanned vehicle by performing the task, it may detect whether its driving trajectory deviates from the target trajectory in real time or regularly. For example, it determines whether the current position of the unmanned vehicle is on the target trajectory, and if yes, it determines that the current position of the unmanned vehicle is not deviated from the target trajectory. In the case that the position of the unmanned vehicle has not deviated from the target trajectory within a period of time, it means that the driving trajectory of the unmanned vehicle has not deviated from the target trajectory during the period of time.

In this embodiment, it may determine whether the unmanned vehicle is backing through the speed of the unmanned vehicle on the longitudinal axis (the axis where the rear axle center pointing to the front axle center). For example, if the speed of the longitudinal axis is positive, it determines that the unmanned vehicle is moving forward; otherwise, if the speed of the longitudinal axis is negative, it determines that the unmanned vehicle is backing. In the case that the unmanned vehicle is detected as being deviated from the target trajectory, if the unmanned vehicle adjusts the driving trajectory, that is, reduces the deviation between the driving trajectory and the target trajectory of the unmanned vehicle by backing, a position on the extension line from the front axle center of the unmanned vehicle to the rear axle center is determined, so that the lateral deviation can be determined subsequently according to the position and the rear axle center.

S22: obtaining a lateral deviation by determining a distance between the target position and the target trajectory.

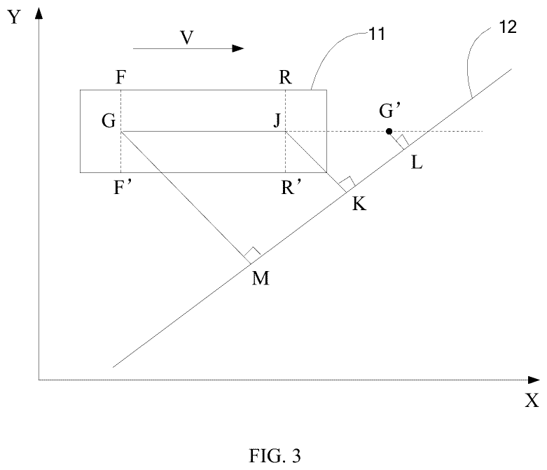

FIG. 3 is a schematic diagram of a lateral deviation according to an embodiment of the present disclosure. As shown in FIG. 3, line segment GJ is the target line segment. The determined target position on the extension line of line segment GJ is G′. By drawing a vertical line from G′ to the target line segment 12 that has the vertical foot of L, LG′ can be obtained as the above-mentioned lateral deviation.

S23: determining a steering angle of the unmanned vehicle based on the lateral deviation, and performing the backing control on the unmanned vehicle based on the steering angle.

In which, the steering angle is equivalent to the turning angle of the direction wheel of the unmanned vehicle. The steering angle is for determining the turning angle of the front wheel of the unmanned vehicle. When the turning angle of the front wheel is changed, the driving trajectory of the unmanned vehicle during backing will also be changed, thereby achieving the backing control of the unmanned vehicle.

In some embodiments, the correspondence between the lateral deviation and the steering angle may be set in advance. After the lateral deviation is determined, the steering angle corresponding to the determined lateral deviation may be found based on the preset correspondence. In other embodiments, the steering angle of the unmanned vehicle may also be determined based on the lateral deviation and other parameters (e.g., the heading angle of the unmanned vehicle).

In this embodiment, in the case that the unmanned vehicle is detected as deviating from the target trajectory during backing, the target position on the extension line of the target line segment is determined, and the lateral deviation of the unmanned vehicle is determined based on the target position. Since the target line segment is the line segment corresponding to the distance between the front axle center and the rear axle center of the unmanned vehicle, the extension direction of the extension line of the target line segment is the direction corresponding to the front axle center pointing to the rear axle center, that is, the extension direction is the same as the current moving direction of the unmanned vehicle. Therefore, the target position determined using the foregoing method is equivalent to the lateral deviation determined according to the forward direction of the unmanned vehicle using the Stanley algorithm while the unmanned vehicle drives forward. In which, when the vehicle is controlled using the Stanley algorithm, it has a smaller control deviation and higher robustness. That is, by determining the lateral deviation through the foregoing method, and determining the steering angle of the unmanned vehicle according to the determined lateral deviation to control the unmanned vehicle, the accuracy of the determined lateral deviation can be improved, thereby improving the accuracy of the backing control of the unmanned vehicle

In some embodiments, the target position may be determined by referencing to the length of the target line segment. In step S21, the obtaining the target position by determining the position on the extension line of the target line segment may include:
obtaining the target position by determining the position on the extension line of the target line segment based on the distance between the front axle center and the rear axle center.

In some embodiments, based on a position coordinate of the front axle center and that of the rear axle center, the distance between the front axle center and the rear axle center, that is, the wheelbase (i.e., the length of the above-mentioned target line segment) is calculated, then the target position on the extension line of the target line segment is determined based on the length of the target line segment.

As an example, it may determine a position (assumed as a first position) between the front axle center and the rear axle center (including the rear axle center), and then determine another position (assumed as a second position) after determining the first position, so that the distance between the second position and the first position is equal to the product of the length of the target line segment and a first preset proportion value. At this time, the second position is the above-mentioned target position. In which, the above-mentioned first preset proportion value is a rational number larger than 0, such as a fraction larger than 0 and less than 1, an integer larger than 1, or the like.

As another example, it may determine a position (assumed as the first position) after determining the rear axle center, and determine another position (assumed as the second position) after determining the first position, so that the distance between the second position and the first position is equivalent to a second preset ratio value of the length of the target line segment. At this time, the second position is the above-mentioned target position. In which, the above-mentioned first preset proportion value is a rational number larger than 0, such as a fraction larger than 0 and less than 1.

In this embodiment, the target position on the extension line of the target line segment is determined based on the distance between the front axle center and the rear axle center, and the distance between the front axle center and the rear axle center is the wheelbase while the changes in the wheelbase will affect the stability and maneuverability of the vehicle. Therefore, the target position determined according to the foregoing method is conducive to improving the accuracy of the obtained target position.

In some embodiments, the obtaining the target position by determining the position on the extension line of the target line segment based on the distance between the front axle center and the rear axle center may include:
obtaining the target position by determining the position on the extension line of the target line segment that has a distance to the rear axle center equal to a distance between the front axle center and the rear axle center.

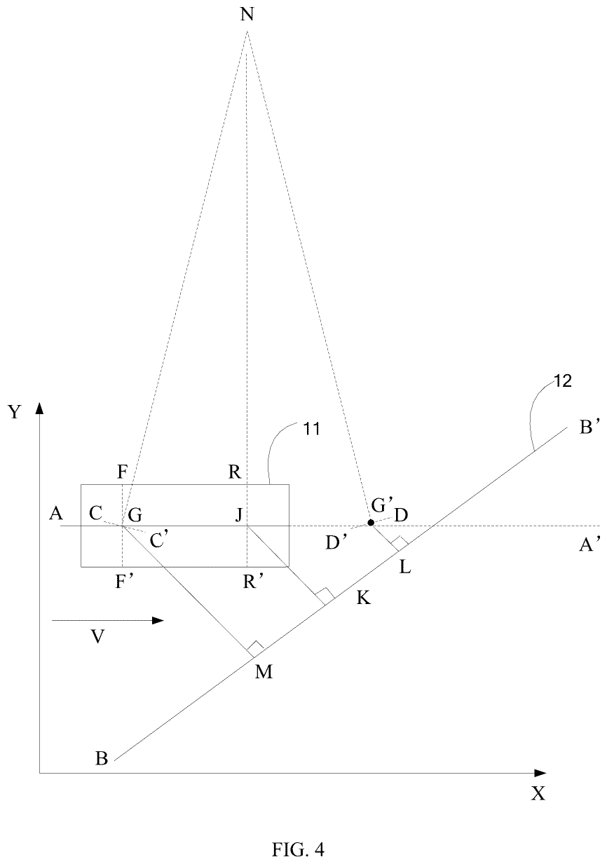

In this embodiment, the specific process of determining the target position is similar to that of determining the target position based on the wheelbase, while there is a difference that the distance between the target position and the rear axle center is defined to be equal to the wheelbase. FIG. 4 is a schematic diagram of a target position determined according to a wheelbase and a rear axle center according to an embodiment of the present disclosure. As shown in FIG. 4, the length of line segment JG′ is equal to that of the line segment GJ, and the included angle between straight line CC′ and straight line AA′ that is less than 90° is a rudder angle. There is a correspondence between the rudder angle and the steering angle, and there is also a corresponding mapping relationship between the rudder angle and the turning angle of each of the two front wheels of the unmanned vehicle. That is, after determining the steering angle, the corresponding rudder angle can be determined, then the turning angle corresponding to the two front wheels of the unmanned vehicle can be further determined based on the rudder angle. In which, straight line NG is perpendicular to straight line CC′, and straight line NG′ is perpendicular to straight line DD′. The position of where point N locates is the corresponding turning center of the unmanned vehicle. When the unmanned vehicle is controlled through the calculated steering angle, the unmanned vehicle will be driven along the arc with the turning center as the center. Since the length of line segment JG′ is equal to that of line segment GJ, determining the lateral distance (i.e., line segment LG′) with G′ is equivalent to determining the lateral distance using the Stanley algorithm. Therefore, when determining the target position using the foregoing method, it will be beneficial to improve the accuracy of the lateral deviation subsequently determined based on the target position.

Considering that the steering angles determined through different lateral deviations are usually different, and different steering angles will also have different control effects on the unmanned vehicle, for example, the control effect of the unmanned vehicle may be under-damped or over-damped, it is necessary to combine the control effects of the unmanned vehicle to select as the position point of the target position. In which, under-damping means that the unmanned vehicle can quickly reduce the deviation from the target trajectory while there is an oscillation, and over-damping means that the unmanned vehicle can reduce the deviation from the target trajectory relatively slower while there is almost no oscillation.

That is, in some embodiments, in step S21, the obtaining the target position by determining the position on the extension line of the target line segment may include:

A1: obtaining a reference position by determining the position on the extension line of the target line segment that has a distance to the rear axle center equal to a distance between the front axle center and the rear axle center.

In some embodiments, the process of determining the reference position is similar to that of determining the target position, and it only needs to be ensured that the distance between the reference position and the rear axle center is equal to the wheelbase.

A2: determining the target position based on a type of an item on the unmanned vehicle and the reference position.

In which, the type of the above-mentioned item may be used to indicate the type of the item. For example, the corresponding type of a ceramic plate is ceramic, and the corresponding type of a glass cup is glass. Otherwise, the type of the item may also be used to indicate whether the item is fragile, where the ceramic and glass products are both fragile.

In some embodiments, it may first determine whether there is an item on the unmanned vehicle. If yes, it may determine the type of the item, and determine that which type of control is suitable for the unmanned vehicle based on the type of the item, for example, determining whether it is suitable for the control of quickly reducing the deviation from the target trajectory that has oscillation, suitable for the control of slowly reducing the deviation from the target trajectory that not has oscillation, or suitable for other types of control.

Since the lateral deviations determined through different target positions are usually different, and the steering angle determined based on the lateral deviation is also usually different while the lateral deviations are different, the determination of the target position will affect the control effect of the unmanned vehicle. For example, if the unmanned vehicle is controlled according to the steering angle determined through different target positions, under-damping or over-damping may occur. If under-damping occurs, the oscillating trajectory could change the position of the item on the unmanned vehicle, and could also cause the item to drop. In addition, since the distance between the reference position and the rear axle center is equal to the wheelbase of the unmanned vehicle, that is, when the lateral deviation is determined based on the reference position and the unmanned vehicle is controlled according to the steering angle determined through the lateral deviation, a smaller control deviation and higher robustness can be achieved. Therefore, in this embodiment, the foregoing target position is determined according to the type of the item on the unmanned vehicle and the reference position, which will be beneficial to improving the matchness of the determined target position with respect to the control effect and the transportation requirement for the type of item.

In some embodiments, considering that the lateral deviation could be infinite while the range of the steering angle is [0°, 90°], that is, although the lateral deviation and the steering angle are positively correlated, they are not in a positive proportional relationship. Therefore, when the lateral deviation is large, if the steering angle is determined based on the lateral deviation and the steering angle is used to reduce the lateral deviation of the unmanned vehicle and the target trajectory, the convergence speed will be slow so that the bumps of the unmanned vehicle are smaller and the damage to the item on the unmanned vehicle is not easy to cause. Therefore, if the item on the unmanned vehicle is easily damaged, the position point that can determine the larger lateral deviation may be selected as the target position. In this case, the foregoing A2 may include:
determining the target position on the extension line of the target line segment in response to the type of the items on the unmanned vehicle being fragile, where the distance between the target position and the target trajectory is larger than the distance between the reference position and the target trajectory.

In some embodiments, since the distance between the target position and the target trajectory is larger than that between the reference position and the target trajectory, if the steering angle is determined based on the large lateral deviation so as to control the unmanned vehicle, the convergence speed of the lateral deviation of the unmanned vehicle will be slow (i.e., the speed of reducing to 0 will be slow), which is equivalent to over-damped. In addition, in the case that the convergence speed of the lateral deviation of the unmanned vehicle is slow that is equivalent to the state of the unmanned vehicle changing at a smaller frequency, since the unmanned vehicle with a smaller frequency of state changes will produce smaller oscillation to the item on the vehicle, which will be beneficial to reducing damage to the item on the vehicle due to state changes.

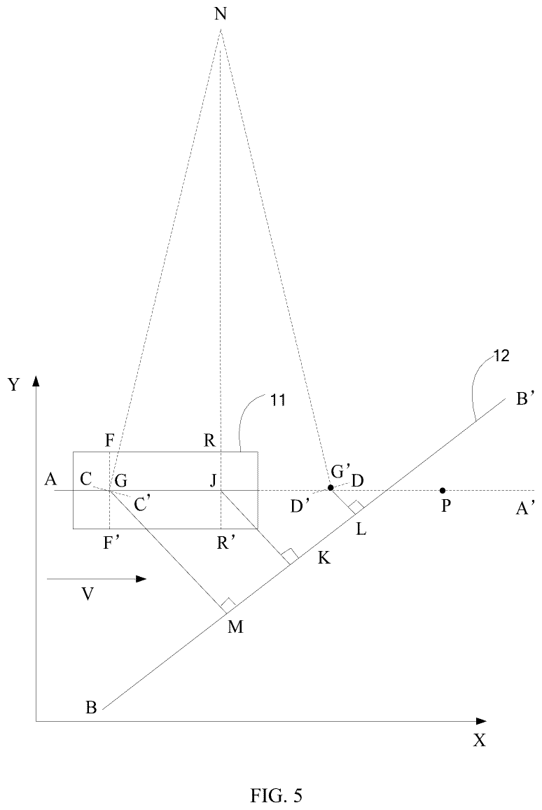

In some embodiments, before determining the target position, it may first determine whether the reference position and the unmanned vehicle are on the same side of the target trajectory. If no, it may determine the target position after determining the reference position; otherwise, if yes, it may determine a position symmetrical to the reference trajectory on the other side of the target trajectory, and determine the target position after determining the position so that the distance between the target position and the target trajectory is larger than that between the reference position and the target trajectory. FIG. 5 is a schematic diagram of determining a target position according to a reference position according to an embodiment of the present disclosure. As shown in FIG. 5, L is the reference position, and a position “P” symmetrical to L that is on the other side of the target trajectory 12 (i.e., straight line BB′) is determined. When it needs to determine a larger lateral deviation, a position may be determined as the above-mentioned target position after determining “P” (i.e., along the positive direction of the X-axis).

The foregoing introduces the scheme for determining the target position when the item is fragile. The following will introduce the solution for determining the target position when the item is non-fragile.

In some embodiments, step A2 may include:
determining the target position on the extension line of the target line segment in response to the type of the items on the unmanned vehicle being non-fragile, where the distance between the target position and the target trajectory is not larger than the distance between the reference position and the target trajectory.

In some embodiments, the distance between the target position and the target trajectory is not larger than that between the reference position and the target trajectory. When the steering angle is determined based on a small lateral deviation so as to control the unmanned vehicle, the lateral deviation of the unmanned vehicle will converge faster (i.e., the speed of reducing to 0 will be fast), which is equivalent to under-damping. In addition, since the item on the unmanned vehicle is not easy to be damaged, the item will not be easily damaged even if some oscillations will be generated by the unmanned vehicle during convergence. Therefore, through the foregoing method, the target position is determined, and the steering angle based on the lateral deviation corresponding to the target position (i.e., the distance between the target position and the target trajectory) is determined, which will be beneficial to improving the convergence speed of the lateral deviation of the unmanned vehicle.

In some embodiments, before determining the target position, a position on the other side of the target trajectory of the target trajectory may be determined, and a position between the position and the reference position may be selected as the target position, so that the distance between the target position and the target trajectory is not larger than that between the reference position and the target trajectory.

In some embodiments, the target position may also be determined in combination with an emergency level of a task. In this case, step A2 may include: determining the target position based on the type of the item on the unmanned vehicle, the emergency level of the task currently executed by the unmanned vehicle, and the reference position.

In some embodiments, the types of items are divided into at least three levels in advance, where different levels correspond to different degrees of vulnerability. When it needs to determine the target position, if it is determined that the task currently executed by the unmanned vehicle is at an emergency level, the corresponding degree of vulnerability will be determined according to the type of the item on the unmanned vehicle. If the degree of vulnerability is not the highest, the position point with a smaller distance with respect to the target trajectory may be selected as the target position so that the distance between the target position and the target trajectory is not larger than that between the reference position and the target trajectory. However, if it is determined that the task currently executed by the unmanned vehicle is at the emergency level and the degree of vulnerability for the type of the item on the unmanned vehicle is the highest, the position point with a larger distance with respect to the target trajectory may be selected as the target position so that the distance between the target position and the target trajectory is larger than that between the reference position and the target trajectory.

Since the emergency level of the task currently executed by the unmanned vehicle is also considered when determining the target position, the accuracy of the determined target position can be improved.

In some embodiments, since the target position is selected from the positions behind the rear of the unmanned vehicle, the sign of the rudder angle corresponding to the target position is opposite to that of the rudder angle corresponding to the front axle center so that a sign inversion operation is required when determining the steering angle, that is, step S23 may include:
B1: determining a candidate steering angle based on the lateral deviation.

In some embodiments, a positive correlation between the lateral deviation and the candidate steering angle may be set in advance. After determining the lateral deviation using the foregoing method, the subsequent steering angle corresponding to the determined lateral deviation may be found according to the positive correlation. Otherwise, it may also calculate a heading deviation of the unmanned vehicle first, then calculate the candidate steering angle based on the heading deviation and the lateral deviation.

B2: obtaining the steering angle of the unmanned vehicle by inverting a sign of the candidate steering angle.

As shown in FIG. 4, if the included angle between straight line DD′ and straight line AA′ that is less than 90° is taken as a first angle, and that between straight line CC′ and straight line AA′ that is less than 90° is taken as a second angle, the sign of the first angle will be opposite to that of the second angle. Therefore, after calculating the candidate steering angle in step B1, the sign of the candidate steering angle is inverted to obtain the angle to use as the steering angle of the unmanned vehicle.

In this embodiment, since the target position is obtained by the subsequent positional selection for the unmanned vehicle, and the sign of the rudder angle on the target position will be opposite to that of the rudder angle on the front axle center, the foregoing processing will be beneficial to improve the accuracy of the steering angle finally obtained.

It should be understood that, the sequence of the serial number of the steps in the above-mentioned embodiments does not mean the execution order while the execution order of each process should be determined by its function and internal logic, which should not be taken as any limitation to the implementation process of the embodiments.

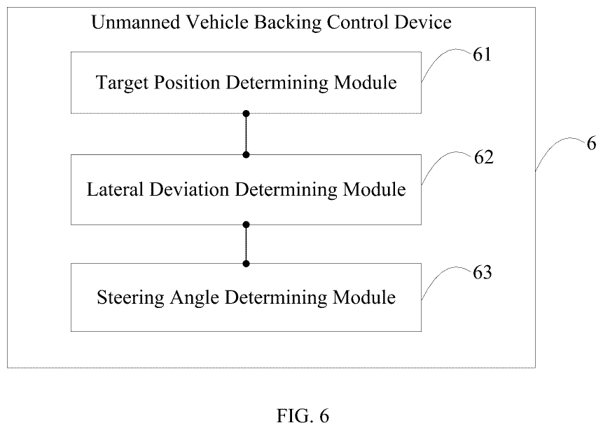

FIG. 6 is a schematic diagram of the structure of an unmanned vehicle backing control apparatus according to an embodiment of the present disclosure. An unmanned vehicle backing control apparatus 6 corresponding to the unmanned vehicle backing control method described in the foregoing embodiment is provided. For convenience of explanation, only the parts related to this embodiment are shown.

As shown in FIG. 6, the unmanned vehicle backing control apparatus 6 is applied to a vehicle, which includes:
a target position determining module 61 configured to obtain a target position by determining a position on an extension line of a target line segment in response to detecting that the unmanned vehicle deviates from a target trajectory during backing; where the target line segment is a line segment corresponding to a distance between a front axle center and a rear axle center of the unmanned vehicle, and an extension direction of the extension line of the target line segment is from the front axle center to the rear axle center.
a lateral deviation determining module 62 configured to obtain a lateral deviation by determining a distance between the target position and the target trajectory; and
a steering angle determining module 63 configured to determine a steering angle of the unmanned vehicle based on the lateral deviation, and performing the backing control on the unmanned vehicle based on the steering angle.

In this embodiment, in the case that the unmanned vehicle is detected as deviating from the target trajectory during backing, the target position on the extension line of the target line segment is determined, and the lateral deviation of the unmanned vehicle is determined based on the target position. Since the target line segment is the line segment corresponding to the distance between the front axle center and the rear axle center of the unmanned vehicle, and the extension direction of the extension line of the target line segment is the direction of the front axle center pointing to the rear axle center, that is, the extension direction is the same as the current moving direction of the unmanned vehicle, the target position determined using the foregoing method will be equivalent to the lateral deviation determined using the Stanley algorithm according to the forward direction of the unmanned vehicle when the unmanned vehicle is driven forward. The Stanley algorithm has a smaller control deviation and higher robustness for vehicle control, that is, by determining the lateral deviation through the foregoing method, and determining the steering angle of the unmanned vehicle based on the determined lateral deviation to control the unmanned vehicle, the accuracy of the determined lateral deviation can be improved, thereby improving the accuracy of the backing control of the unmanned vehicle.

In some embodiments, the target position determining module 61 may be configured to obtain the target position by determining the position on the extension line of the target line segment by:
obtaining the target position by determining the position on the extension line of the target line segment based on the distance between the front axle center and the rear axle center.

In some embodiments, the target position determining module 61 may be configured to obtain the target position by determining the position on the extension line of the target line segment based on the distance between the front axle center and the rear axle center by:
obtaining the target position by determining the position on the extension line of the target line segment that has a distance to the rear axle center equal to a distance between the front axle center and the rear axle center.

In some embodiments, the above-mentioned target position determining module 61 may be configured to obtain the target position by determining the position on the extension line of the target line segment using:
a reference position determining unit configured to obtain a reference position by determining the position on the extension line of the target line segment that has a distance to the rear axle center equal to a distance between the front axle center and the rear axle center.
a target position determining unit configured to determine the target position based on a type of an item on the unmanned vehicle and the reference position.

In some embodiments, the target position determining unit may be configured to determine the target position on the extension line of the target line segment in response to the type of the items on the unmanned vehicle being fragile, where the distance between the target position and the target trajectory is larger than the distance between the reference position and the target trajectory.

In some embodiments, before determining the target position, it may first determine whether the reference position and the unmanned vehicle are on the same side of the target trajectory. If no, it may determine the target position after determining the reference position; otherwise, if yes, it may determine a position symmetrical to the reference trajectory on the other side of the target trajectory, and determine the target position after determining the position so that the distance between the target position and the target trajectory is larger than that between the reference position and the target trajectory.

In some embodiments, the target position determining unit may be configured to:
determining the target position on the extension line of the target line segment in response to the type of the items on the unmanned vehicle being non-fragile, where the distance between the target position and the target trajectory is not larger than the distance between the reference position and the target trajectory

In some embodiments, before determining the target position, a position on the other side of the target trajectory of the target trajectory may be determined, and a position between the position and the reference position may be selected as the target position, so that the distance between the target position and the target trajectory is not larger than that between the reference position and the target trajectory.

In some embodiments, the target position may also be determined in combination with an emergency level of a task. In this case, the target position determining unit may be configured to: determining the target position based on the type of the item on the unmanned vehicle, the emergency level of the task currently executed by the unmanned vehicle, and the reference position.

In some embodiments, the steering angle determining module 63 may be configured to determine the steering angle of the unmanned vehicle based on the lateral deviation by:
determining a candidate steering angle based on the lateral deviation; and
obtaining the steering angle of the unmanned vehicle by inverting a sign of the candidate steering angle.

It should be noted that, the information exchange, execution process and other contents between the above-mentioned device/units are based on the same concept as the method embodiments of the present disclosure. For the specific functions and technical effects, please refer to the method embodiments.

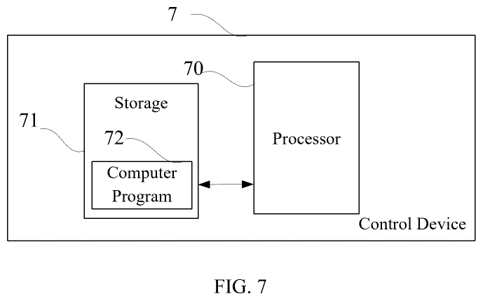

FIG. 7 is a schematic diagram of the structure of a control device according to an embodiment of the present disclosure. A control device 7 for an unmanned vehicle is provided. As shown in FIG. 7, in this embodiment, the control device 7 may include at least one processor 70 (only one processor is shown in the figure), a storage 71, and a computer program 72 that is stored in the storage 71 and can be executed on the processor 70. When the processor 70 executes the computer program 72, the steps in any of the above-mentioned method embodiments are implemented.

The above-mentioned control device 7 is applied to a vehicle. The control device 7 may include, but is not limited to, the processor 70 and the storage 71. It can be understood by those skilled in the art that FIG. 7 is merely an example of the control device 7 and does not constitute a limitation on the control device 7, and may include more or fewer components than those shown in the figure, or a combination of some components or different components. For example, the control device 7 may further include an input/output device, a network access device, and the like.

The processor 70 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

In some embodiments, the storage may be an internal storage unit of the control device, for example, a hard drive or a memory of the control device. In other embodiments, the storage may also be an external storage device of the control device, for example, a plug-in hard drive, a smart media card (SMC), a secure digital (SD) card, or a flash card that is equipped on the control device. The storage may also include both the internal storage units and the external storage devices of the control device. The storage may be configured to store operating systems, applications, boot loaders, data, and other programs such as codes of computer programs. The storage may also be configured to temporarily store data that has been output or will be output.

Those skilled in the art may clearly understand that, for the convenience and simplicity of description, the division of the above-mentioned functional units or modules is merely an example for illustration. In actual applications, the above-mentioned functions may be allocated to be performed by different functional units or modules according to requirements, that is, the internal structure of the device may be divided into different functional units or modules to complete all or part of the above-mentioned functions. The functional units or modules in the embodiments may be integrated in one processing unit, or each unit, may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units or modules in the above-mentioned system, reference may be made to the corresponding processes in the above-mentioned method embodiments, and are not described herein.

The present disclosure further provides a control device which includes at least one processor, a storage, and a computer program stored in the storage and executed on the at least one processor, where the steps in any of the above-mentioned method embodiments are implemented when the processor executes the computer program.

The present disclosure further provides a computer-readable storage medium. The computer-readable storage medium is stored with a computer program. When the computer program is executed by a processor, the steps in each of the above-mentioned method embodiments can be implemented.

The present disclosure further provides a computer program product. When the computer program product is executed on the control device, the control device can implement the steps in the above-mentioned method embodiments.

When the integrated unit is implemented in the form of a software functional unit and is sold or used as an independent product, the integrated unit may be stored in a non-transitory computer-readable storage medium. Based on this understanding, all or part of the processes in the method for implementing the above-mentioned embodiments of the present disclosure are implemented, and may be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include at least any entity or device, a recording medium, a computer memory, a read-only memory (ROM), a random access memory (RAM), electric carrier signals, telecommunication signals and software distribution media that is capable of carrying the computer program codes on the control device, for example, a USB flash drive, a portable hard disk, a magnetic disk, an optical disk, or the like. In some jurisdictions, according to the legislation and patent practice, the computer-readable medium cannot be the electric carrier signals and the telecommunication signals.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device) and method may be implemented in other manners. For example, the above-mentioned apparatus embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A control method for backing an unmanned vehicle, comprising:
obtaining a target position by determining a position on an extension line of a target line segment in response to detecting that the unmanned vehicle deviates from a target trajectory during backing, wherein the target line segment is a line segment corresponding to a distance between a front axle center and a rear axle center of the unmanned vehicle, and an extension direction of the extension line of the target line segment is from the front axle center to the rear axle center;
obtaining a lateral deviation by determining a distance between the target position and the target trajectory; and
determining a steering angle of the unmanned vehicle based on the lateral deviation, and performing a backing control on the unmanned vehicle based on the steering angle.

2. The method of claim 1, wherein obtaining the target position by determining the position on an extension line of the target line segment comprises:
obtaining the target position by determining the position on the extension line of the target line segment based on the distance between the front axle center and the rear axle center.

3. The method of claim 2, wherein obtaining the target position by determining the position on the extension line of the target line segment based on the distance between the front axle center and the rear axle center comprises:
obtaining the target position by determining the position on the extension line of the target line segment that has a distance to the rear axle center equal to a distance between the front axle center and the rear axle center.

4. The method of claim 1, wherein obtaining the target position by determining the position on an extension line of the target line segment comprises:
obtaining a reference position by determining the position on the extension line of the target line segment that has a distance to the rear axle center equal to a distance between the front axle center and the rear axle center; and
determining the target position based on a type of an item on the unmanned vehicle and the reference position.

5. The method of claim 4, wherein determining the target position based on the type of items on the unmanned vehicle and the reference position comprises:
determining the target position on the extension line of the target line segment in response to the type of the items on the unmanned vehicle being fragile, wherein the distance between the target position and the target trajectory is larger than the distance between the reference position and the target trajectory.

6. The method of claim 4, wherein determining the target position based on the type of items on the unmanned vehicle and the reference position comprises:
determining the target position on the extension line of the target line segment in response to the type of the items on the unmanned vehicle being non-fragile, wherein the distance between the target position and the target trajectory is not larger than the distance between the reference position and the target trajectory.

7. The method of claim 1, wherein determining the steering angle of the unmanned vehicle based on the lateral deviation comprises:
determining a candidate steering angle based on the lateral deviation; and
obtaining the steering angle of the unmanned vehicle by inverting a sign of the candidate steering angle.

8. An unmanned vehicle, comprising:
a processor;
a memory coupled to the processor; and
one or more computer programs stored in the memory and executable on the processor;
wherein, the one or more computer programs comprise:
instructions for obtaining a target position by determining a position on an extension line of a target line segment in response to detecting that the unmanned vehicle deviates from a target trajectory during backing, wherein the target line segment is a line segment corresponding to a distance between a front axle center and a rear axle center of the unmanned vehicle, and an extension direction of the extension line of the target line segment is from the front axle center to the rear axle center;
instructions for obtaining a lateral deviation by determining a distance between the target position and the target trajectory; and
instructions for determining a steering angle of the unmanned vehicle based on the lateral deviation, and performing a backing control on the unmanned vehicle based on the steering angle.

9. The unmanned vehicle of claim 8, wherein the instructions for obtaining the target position by determining the position on an extension line of the target line segment comprise:
instructions for obtaining the target position by determining the position on the extension line of the target line segment based on the distance between the front axle center and the rear axle center.

10. The unmanned vehicle of claim 9, wherein the instructions for obtaining the target position by determining the position on the extension line of the target line segment based on the distance between the front axle center and the rear axle center comprise:
instructions for obtaining the target position by determining the position on the extension line of the target line segment that has a distance to the rear axle center equal to a distance between the front axle center and the rear axle center.

11. The unmanned vehicle, of claim 8, wherein the instructions for obtaining the target position by determining the position on an extension line of the target line segment comprise:
instructions for obtaining a reference position by determining the position on the extension line of the target line segment that has a distance to the rear axle center equal to a distance between the front axle center and the rear axle center; and
instructions for determining the target position based on a type of an item on the unmanned vehicle and the reference position.

12. The unmanned vehicle of claim 11, wherein the instructions for determining the target position based on the type of items on the unmanned vehicle and the reference position comprise:
instructions for determining the target position on the extension line of the target line segment in response to the type of the items on the unmanned vehicle being fragile, wherein the distance between the target position and the target trajectory is larger than the distance between the reference position and the target trajectory.

13. The unmanned vehicle of claim 11, wherein the instructions for determining the target position based on the type of items on the unmanned vehicle and the reference position comprise:
instructions for determining the target position on the extension line of the target line segment in response to the type of the items on the unmanned vehicle being non-fragile, wherein the distance between the target position and the target trajectory is not larger than the distance between the reference position and the target trajectory.

14. The unmanned vehicle of claim 8, wherein the instructions for determining the steering angle of the unmanned vehicle based on the lateral deviation comprise:
instructions for determining a candidate steering angle based on the lateral deviation; and
instructions for obtaining the steering angle of the unmanned vehicle by inverting a sign of the candidate steering angle.

15. A non-transitory computer-readable storage medium for storing one or more computer programs, wherein the one or more computer programs comprise:
instructions for obtaining a target position by determining a position on an extension line of a target line segment in response to detecting that an unmanned vehicle deviates from a target trajectory during backing, wherein the target line segment is a line segment corresponding to a distance between a front axle center and a rear axle center of the unmanned vehicle, and an extension direction of the extension line of the target line segment is from the front axle center to the rear axle center;
instructions for obtaining a lateral deviation by determining a distance between the target position and the target trajectory; and
instructions for determining a steering angle of the unmanned vehicle based on the lateral deviation, and performing a backing control on the unmanned vehicle based on the steering angle.

16. The storage medium of claim 15, wherein the instructions for obtaining the target position by determining the position on an extension line of the target line segment comprise:
instructions for obtaining the target position by determining the position on the extension line of the target line segment based on the distance between the front axle center and the rear axle center.

17. The storage medium of claim 16, wherein the instructions for obtaining the target position by determining the position on the extension line of the target line segment based on the distance between the front axle center and the rear axle center comprise:
instructions for obtaining the target position by determining the position on the extension line of the target line segment that has a distance to the rear axle center equal to a distance between the front axle center and the rear axle center.

18. The storage medium of claim 15, wherein the instructions for obtaining the target position by determining the position on an extension line of the target line segment comprise:
instructions for obtaining a reference position by determining the position on the extension line of the target line segment that has a distance to the rear axle center equal to a distance between the front axle center and the rear axle center; and
instructions for determining the target position based on a type of an item on the unmanned vehicle and the reference position.

19. The storage medium of claim 18, wherein the instructions for determining the target position based on the type of items on the unmanned vehicle and the reference position comprise:
instructions for determining the target position on the extension line of the target line segment in response to the type of the items on the unmanned vehicle being fragile, wherein the distance between the target position and the target trajectory is larger than the distance between the reference position and the target trajectory.

20. The storage medium of claim 18, wherein the instructions for determining the target position based on the type of items on the unmanned vehicle and the reference position comprise:
instructions for determining the target position on the extension line of the target line segment in response to the type of the items on the unmanned vehicle being non-fragile, wherein the distance between the target position and the target trajectory is not larger than the distance between the reference position and the target trajectory.
